(19) United States
(12) Patent Application Publication
(10) Pub. No.: US 2025/0376021 A1
(43) Pub. Date: Dec. 11, 2025

(54) TANK FLAP SYSTEM FOR A MOTOR VEHICLE

(71) Applicant: BOS GmbH & Co. KG, Ostfildern (DE)

(72) Inventors: Emmanuel Matanzo DELGADO, Shelby Township, MI (US); Roberto Cabral GRIMALDO, Southfield, MI (US)

(21) Appl. No.: 19/229,142

(22) Filed: Jun. 5, 2025

Related U.S. Application Data
(60) Provisional application No. 63/656,783, filed on Jun. 6, 2024.

(51) Int. Cl. B60K 15/05

(52) U.S. Cl. CPC B60K 15/05; B60K 2015/053

(57) ABSTRACT

A tank flap system including a base fixed to the vehicle, and a tank flap mounted on the base by a four-joint mechanism so as to be movable between a closed position closing a tank recess and an open position exposing the tank recess. The system further includes a drive motor coupled to the four-joint mechanism to move the tank flap between the closed position and the open position and a coupling lever connecting a crank rocker, co-rotating with a drive shaft of the drive motor, to the four-joint mechanism in a movement-transmitting manner to move the four-joint mechanism between the closed position and the open position of the tank flap when the drive motor is activated, and the crank rocker and the coupling lever are in the closed position of the four-joint mechanism, movable into an over-center position blocking an opening movement of the four-joint mechanism.

### CROSS-REFERENCE TO RELATED APPLICATION

This claims priority from U.S. Provisional Application No. 63/656,783, filed Jun. 6, 2024, the disclosure of which is hereby incorporated by reference in its entirety.

### TECHNICAL FIELD

The invention relates to a tank flap system for a motor vehicle, with a base fixed to the vehicle in the state assembled ready for operation, and with a tank flap which is mounted on the base by means of a four-joint mechanism so as to be movable between a closed position closing a tank recess and an open position exposing the tank recess, and with a drive motor coupled to the four-joint mechanism, in order to move the tank flap between the closed position and the open position.

### BACKGROUND AND SUMMARY

A tank flap system of this type is generally known for a motor vehicle with a purely electric motor drive. In the region of an outer contour of a vehicle body of the passenger car, a tank recess fixed to the vehicle is provided, in which at least one power connection is fitted for charging a battery pack feeding the drive. The tank recess is closable by means of a tank flap, which in its closed position is flush with an outer bodywork shell of the vehicle body. The tank flap is mounted by means of a four-joint mechanism so as to be movable between the closed position and an open position, wherein the tank flap in its open position projects outwards beyond an outer contour of the vehicle body. To move the tank flap between the closed position and the open position, an electric drive motor that interacts with the four-joint mechanism is provided.

One object of the invention is to provide a tank flap system of the type stated at the outset that permits a secure positioning of the tank flap in at least one end position.

This is achieved in that a coupling lever is provided which connects a crank rocker, co-rotating with a drive shaft of the drive motor, to the four-joint mechanism in a movement-transmitting manner, in order to move the four-joint mechanism between the closed position and the open position of the tank flap when the drive motor is activated, and in that the crank rocker and the coupling lever are, in the closed position of the four-joint mechanism, movable into an over-center position which blocks an opening movement of the four-joint mechanism. The over-center position is a position beyond a dead center which completely mechanically locks the four-joint mechanism. This solution is suitable both for refueling with electricity and for liquid refueling. The tank or fuel filler flap system is therefore suitable both for motor vehicles with an electric motor drive and for motor vehicles with a combustion engine-based drive. The coupling lever may be connected, either directly with a lever joint of the four-joint mechanism or indirectly via a drive lever acting on the tank or fuel filler flap, to the four-joint mechanism in a movement-transmitting manner. An electric drive motor is preferably provided as the drive motor. The transfer of the crank rocker and of the coupling lever in the closed position into an over-center position ensures that the tank flap when located in its closed position is locked in place in this closed position. The tank flap can therefore not be moved in the direction of the open position by a manual action on the tank flap itself. Instead, it is only the activation of the drive motor that effects a turn of the crank rocker and thereby ends the over-center position, so that an opening movement of the four-joint mechanism leading to the required opening movement of the tank flap is not possible until the over-center position has been ended.

In one embodiment of the invention, an emergency unlocking lever is co-rotatingly arranged on the drive shaft or on the crank rocker and is manually operable, directly or indirectly, to move the crank rocker and the coupling lever out of the over-center position in the direction of the open position. Co-rotatingly means torque proof or in other words fix to each other in a rotating direction. This embodiment is advantageous in the event that the drive motor is not activatable. If the drive motor is designed as an electric drive motor, a power failure would prevent activation of the drive motor. The emergency unlocking lever ensures that the over-center position can be ended purely mechanically by a manual movement. To do so, the emergency unlocking lever can be moved either directly by an action of an operator's hand or by an action by means of a hand-held tool, or the emergency unlocking lever is moved indirectly in that a remote transmission element, such as, in particular, a Bowden cable or similar device, acts on the emergency unlocking lever, which is in turn manually actuated.

Additionally, a drive lever is provided which is rotatably joined to the base on the base side and to the tank flap on the flap side, and the coupling lever is joined to a base-side end region of the drive lever at a distance to a base-side rotary axis of the drive lever in order to transmit rotary movements of the crank rocker to the drive lever. The drive lever is used to control the tank flap between its closed position and its open position. The direct action by the drive lever on the tank flap ensures a secure positioning of the tank flap both in the closed position and in the open position. The drive lever is provided in addition to the four-joint mechanism, wherein preferably all articulation points of the drive lever and of an articulated lever of the four-joint mechanism are aligned coaxially to one another.

In a further embodiment, a braking member acts on the base-side end region of the drive lever and stabilizes at least one position of the drive lever against relative movements caused by outside influences. The braking member stabilizes the base-side mounting of the drive lever, such that relative movements or vibrations acting on the tank flap are attenuated or eliminated in at least one position of the tank flap.

In a further embodiment, the base-side end region of the drive lever and the braking member have contact contours matching one another, which effect a force-limited braking or attenuating effect for the at least one position of the drive lever. A non-positive and/or positive connection between the contact contours ensures stabilization of the base-side end region of the drive lever and hence of the entire drive lever and of the tank flap.

In a further embodiment, a leaf spring arranged on the base is provided as a braking member and interacts with the contact contour of the base-side end region of the drive lever. The leaf spring is a particularly simple and effective variant of a braking member. The leaf spring is in permanent contact with an outer contour, acting as a contact contour, of the base-side end region of the drive lever.

In a further embodiment, the drive lever is associated with a spring arrangement which exerts on the drive lever a permanent torque countering a gravitational torque exerted by gravity of the tank flap, in particular in the direction of the closed position of the tank flap, wherein the torque is lower than a torque of the drive motor for moving the drive lever, in particular into the open position of the tank flap. The spring arrangement ensures rattle-free and vibration-free positioning of the tank flap in its closed position.

In a further embodiment, the spring arrangement is designed as a torsion spring which acts coaxially to the rotary axis of the base-side end region of the drive lever and in a manner transmitting torque to the drive lever. The torsion spring is joined to the base at one end and to the end region of the drive lever at the other end, in order to thereby introduce the required permanent torque into the drive lever. The torsion spring is pre-loaded both in the closed position and in the open position of the tank flap, wherein the torsion spring exerts a permanent torque in the direction of the closed position of the tank flap.

### BRIEF DESCRIPTION OF THE DRAWINGS

FIG. 1 illustrates a tank flap system for a motor vehicle, with the cover removed for clarity;

FIG. 2 is a side view of the tank flap system of FIG. 1, with the flap support in the closed position;

FIG. 3 is a side view of the tank flap system of FIG. 1, with the flap support in the open position;

FIG. 4 is a rear view of the tank flap system of FIG. 1;

FIG. 5 illustrates the drive lever, the carrier shaft and surrounding components;

FIG. 6 is an exploded view of the drive lever and surrounding components; and

FIGS. 7 and 8 are side views of the drive lever illustrating positions of the coupling lever and the crank rocker.

### DETAILED DESCRIPTION

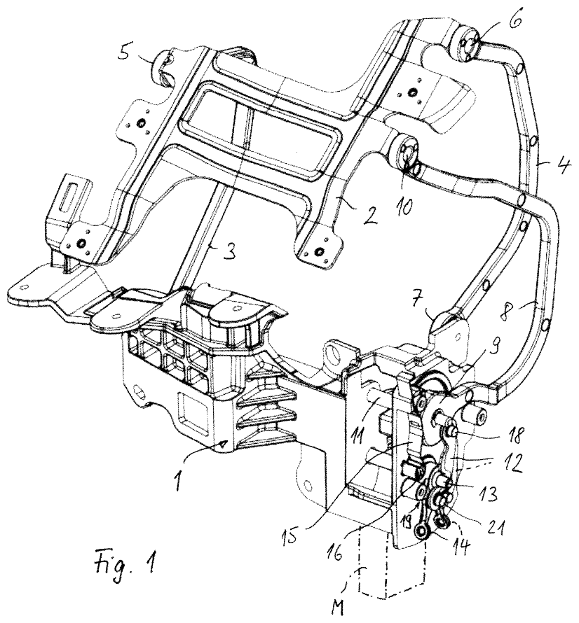

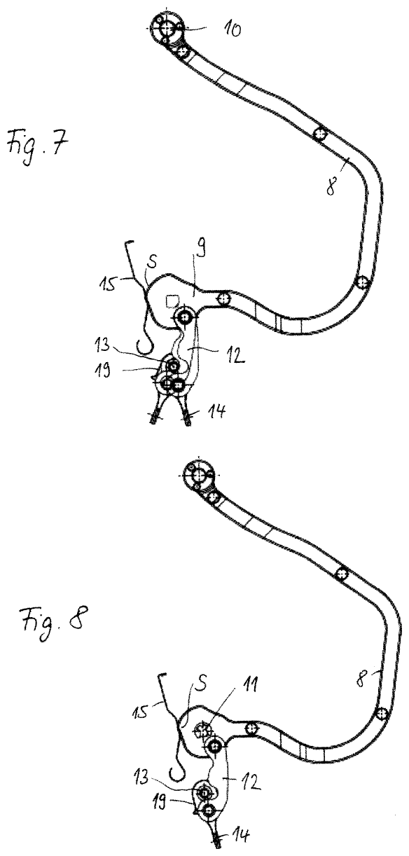

A tank flap system according to FIGS. 1 to 8 is provided for a motor vehicle in a manner not shown in detail, wherein the tank flap system is provided in the region of an outer contour of a vehicle body. On the vehicle side, a cutout is provided in an outer bodywork shell of the vehicle body, inside which a tank recess is positioned which has at least one refueling connection. The refueling connection may be designed as an electric fuel connection or as a nozzle-like liquid fuel connection. The cutout in the outer bodywork shell is closable by a cover, not shown, of a tank flap. The cover of the tank flap is fastened on a flap support 2. The flap support 2 and the cover, not shown, form the tank flap in the meaning of the invention. For reasons of clarity, FIGS. 1 to 4 show only the flap support 2 made as a bent sheet-metal part. The cover is fastened on the outside of the flap support 2.

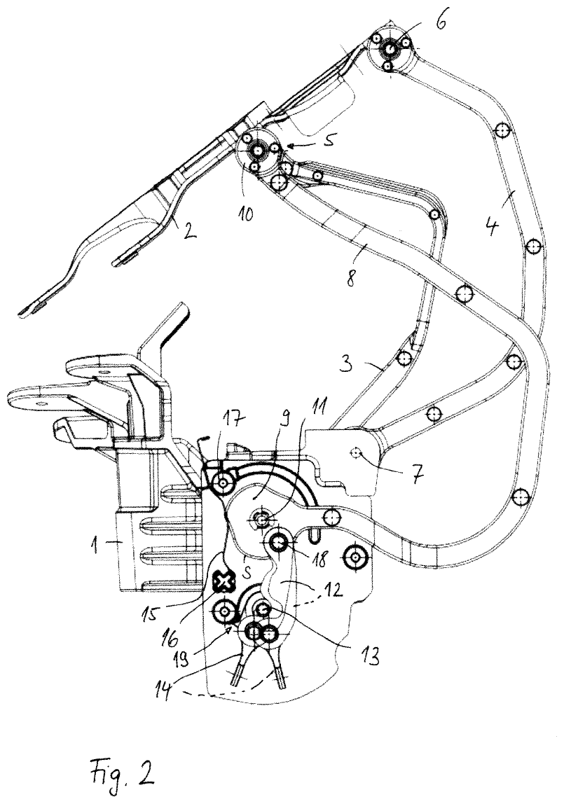

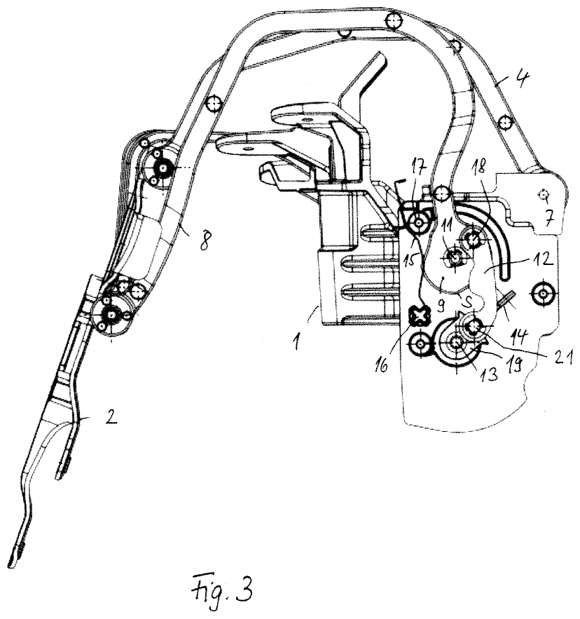

The flap support 2 is mounted relative to a base 1, fixed to the vehicle in the state assembled ready for operation, so as to be movable between a closed position (FIGS. 1 and 2) and an open position (FIG. 3) by means of a four-joint mechanism described in more detail in the following description. In the closed position, the tank recess and the cutout in the outer bodywork shell are closed by the tank flap, wherein the cover of the tank flap is flush with the outer bodywork shell in the closed position. In the open position, the tank flap is moved downwards, thereby exposing the tank recess and the cutout in the outer bodywork shell, to allow connection of a fuel nozzle or of an electric charging cable to the refueling connection.

The base 1 is mounted fixed to the vehicle in the region of the tank recess. The four-joint mechanism has two articulated levers 3 and 4 spaced at a distance from one another and each is rotatably connected to the base 1 via a lower articulation point or pivot bearing 7 and rotatably connected to the flap support 2 via an upper articulation point 5 and 6 respectively. All rotary axes of the articulation points are aligned parallel to one another. The articulated lever 4 is curved like a bow. The articulated lever 3 is curved and is also angled approximately at right angles in an upper section for a transition to the upper articulation point 5.

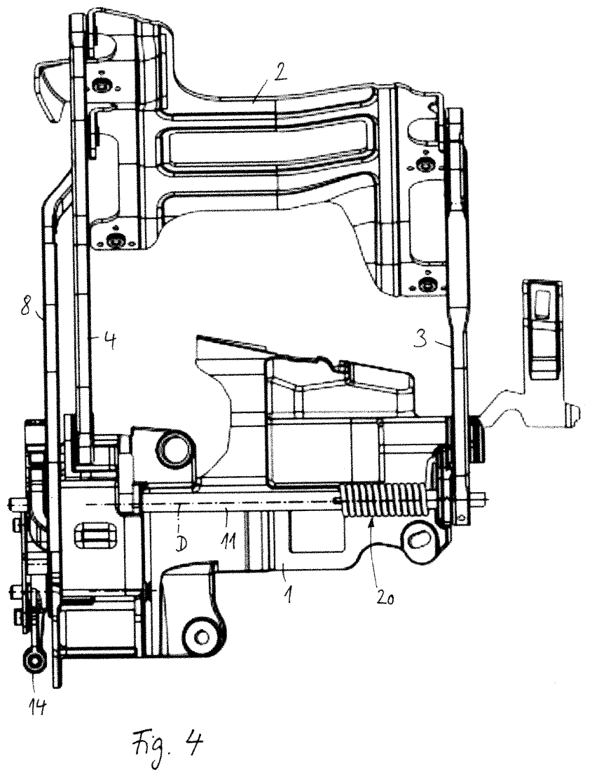

A drive lever 8 also acts on the flap support 2, coaxially to the rotary axis of the upper articulation point 5 of the articulated lever 3, but on an opposite side region of the flap support 2. The drive lever 8 has here an upper pivot bearing 10 whose rotary axis is aligned coaxially to the rotary axis of the articulation point 5. The pivot bearing 10 is thus positioned in a flap-side end region of the drive lever 8. The drive lever 8 has an opposite, base-side end region 9, which is rotatably mounted on the base 1 coaxially to a rotary axis D (FIG. 4). The rotary axis D too extends parallel to the rotary axes of the articulation points 5, 6 and 7.

Both the articulated lever 3 and the articulated lever 4 are rotatably mounted on the base 1, wherein the lower pivot bearing 7 of the articulated lever 4 can be discerned in the drawings. A lower pivot bearing of the articulated lever 3 cannot however be directly discerned in the drawings.

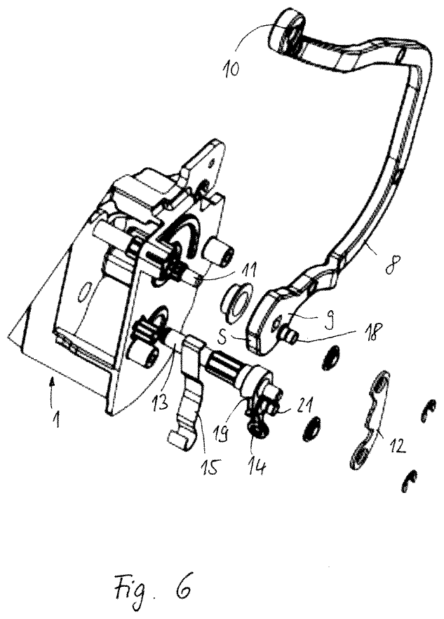

The flap-side end region 9 of the drive lever 8 has a control contour in the region of its outer circumference which is made up of several circumferential sections adjoining one another in the circumferential direction. The contour sections of a control contour S interact with a braking member in the form of a leaf spring 15 which exerts a permanent compression spring force onto the control contour S radially to the rotary axis D, depending on the pivot position of the drive lever 8. The leaf spring 15 is joined to a lower end on the base 1 via a bearing point 16 and is supported above the end region 9 of the drive lever 8 by a supporting bolt 17 arranged on the base 1. The base 1 also has a web-like housing section that supports the leaf spring 15 opposite to the supporting bolt 17, as can be discerned from FIGS. 1 and 2. The control contour S has differently designed contour sections adjoining one another in the circumferential direction, wherein in each case a convex contour section follows a concave contour section and vice versa, relative to a rotation direction of the drive lever 8. The leaf spring 15 has, as can be readily discerned from FIGS. 6 to 8, a counter-curvature matching the control contour S such that the leaf spring 15 can exert with a limited force a non-positive or positive retaining function, i.e. a braking function, on the end region 9 and hence on the drive lever 8.

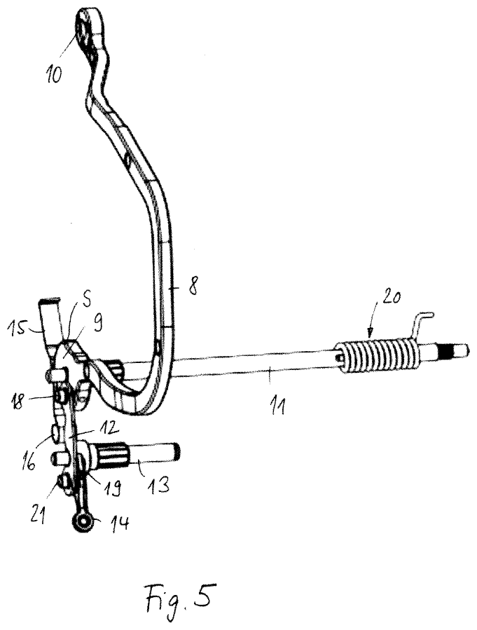

The base-side end region 9 of the drive lever 8 is also co-rotatingly connected to a carrier shaft 11 which is rotatable coaxially to the rotary axis D and is mounted on the base 1 in a longitudinally extending manner. The carrier shaft 11 is rotatably mounted, on a side of the base 1 opposite to the drive lever 8, on a bearing block, not indicated in detail, of the base 1, in the present case coaxially to a lower articulation point, not indicated in detail, of the articulated lever 3. The carrier shaft 11 is co-rotatingly connected to the articulated lever 3 in the region of its lower articulation point, so that the carrier shaft 11 is used for synchronization of the rotary movement of the drive lever 8 on the one hand and of the articulated lever 3 on the other. A torsion spring 20 acting as the spring arrangement and designed as a helical spring acts on the carrier shaft 11. As can be discerned from FIGS. 4 and 5, the torsion spring 20 is joined co-rotatingly to the carrier shaft 11 at one end and stationarily to the base 1 at the other end. The torsion spring 20 exerts a permanent torque on the drive lever 8 and on the articulated lever 3 in the direction of the closed position of the tank flap.

A drive torque, which a drive motor M (shown in dotted lines in FIG. 1) exerts on the drive lever 8 via the drive shaft 13, the crank rocker 19 and the coupling lever 12, is greater in the opening direction of the tank flap than the opposite torque of the torsion spring 20. The torsion spring 20 accordingly stabilizes the drive movement of the drive motor M.

The tank flap and hence the flap support 2 are driven by means of an electric drive motor M (FIG. 1) stationarily fastened to the base 1. The drive motor M has a transmission and a drive shaft 13, which is coupled to the drive lever 8 in the manner described in more detail below and adjoins the transmission on the power takeoff side, in order to achieve a movement of the flap support 2 between the closed position and the open position using the four-joint mechanism formed by the articulated levers 3 and 4. To do so, a crank rocker 19 is fastened on the drive shaft 13 and projects radially to a rotary axis of the drive shaft 13. On the crank rocker 19, at a radial distance from the rotary axis of the drive shaft 13, a swivel joint 21 is provided via which a coupling lever 12 is rotatably connected to the crank rocker 19. The coupling lever 12 is connected in articulated manner to the base-side end region 9 of the drive lever 8 by means of an opposite swivel joint 18 at a radial distance to the rotary axis D. Both swivel joints 18 and 21 have rotary axes which extend parallel to the rotary axis D and parallel to the rotary axis of the drive shaft 13.

It can be discerned from FIGS. 1, 2 and 7 that the coupling lever 12 and the crank rocker 19 are, in the closed position of the tank flap, transferable into a over-center position relative to the rotary axis of the drive shaft 13. To make this clearer, FIGS. 1, 2 and 7 each show on the left the positioning of the coupling lever 12 and of the crank rocker 19 in the over-center position, and on the right the positioning of the coupling lever 12 and crank rocker 19 after ending of the over-center position, but still in the closed position of the tank flap. The coupling lever 12 is provided at the level of the drive shaft 13 with an indentation, so that during a movement of the coupling lever 12 into the over-center position the drive shaft 13 inserts itself into this indentation and thus does not impair the movement of the coupling lever 12. The drive motor M can effect this over-center position by a clockwise direction of rotation-in respect of the drawings-and end this over-center position by an opposite rotation in the counterclockwise direction. In a further rotary movement of the drive motor M towards the drive shaft 13 in the counterclockwise direction, the coupling lever 12 is moved upwards until the coupling lever 12 has reached the position as per FIG. 3. In this position the open position of the tank flap has been reached.

To allow movement of the tank flap out of the closed position in the direction of the open position even in the event of failure of the drive motor M, in particular in the event of a power failure, an emergency unlocking feature is associated with the tank flap system. In this case an emergency unlocking lever 14 is arranged co-rotatingly and directly on the drive shaft 13, wherein the emergency unlocking lever 14 may either be a component separate from the crank rocker 19 or be designed as an extension of the crank rocker 19. In the example shown, the emergency unlocking lever 14 is designed as a radial extension of the crank rocker 19, as can be discerned from FIG. 6. The emergency unlocking lever 14 may be designed here as a one-piece extension of the crank rocker 19 or as a separately made extension permanently connected to the crank rocker 19.

As can be discerned from the drawings, the emergency unlocking lever 14 has at its free end region an eyelet which is provided for attachment of a cable pull, in particular in the form of a Bowden cable. Alternatively, the emergency unlocking lever 14 may be rotated directly by one operator by means of a hand-held tool. A tensile load on this cable pull, in particular on a Bowden cable, is applied by hand by one operator during the action of a cable pull too.

A rotary movement in the counterclockwise direction (relative to the plane of the drawing) exerted on the emergency unlocking lever 14 in the closed position of the tank flap inevitably leads initially to an end to the over-center position between crank rocker 19 and coupling lever 12 and then to a movement of the coupling lever 12 upwards, whereby inevitably the drive lever 8 too is rotated in the counterclockwise direction and the flap support 2 is moved in the direction of its open position. The tank recess is then free, permitting a refueling with electric power or liquid fuel.

1. A tank flap system for a motor vehicle, comprising:
a base fixed to the motor vehicle in a state assembled ready for operation;
a tank flap;
a four-joint mechanism, the tank flap being mounted on the base by the four-joint mechanism-so as to be movable between a closed position closing a tank recess and an open position exposing the tank recess;
a drive motor coupled to the four-joint mechanism in order to move the tank flap between the closed position and the open position, the drive motor having a drive shaft;
a crank rocker; and
a coupling lever the crank rocker, co-rotating with the drive shaft of the drive motor, to the four-joint mechanism in a movement-transmitting manner, in order to move the four-joint mechanism between the closed position and the open position of the tank flap when the drive motor is activated, the crank rocker and the coupling lever being, in the closed position of the four-joint mechanism, movable into an over-dead center position which blocks an opening movement of the four-joint mechanism.

2. The tank flap system according to claim 1, further including an emergency unlocking lever co-rotatingly arranged on the drive shaft or on the crank rocker and being manually operable, directly or indirectly, to move the crank rocker and the coupling lever out of the over-dead center position in the direction of the open position.

3. The tank flap system according to claim 1, further including a drive lever rotatably joined to the base on a base side and to the tank flap on a flap side, and the coupling lever is joined to a base-side end region of the drive lever at a distance to a base-side rotary axis of the drive lever in order to transmit rotary movements of the crank rocker to the drive lever.

4. The tank flap system according to claim 3, further including a braking member acting on the base-side end region of the drive lever and stabilizing at least one position of the drive lever against relative movements caused by outside influences.

5. The tank flap system according to claim 4, wherein the base-side end region of the drive lever and the braking member have contact contours matching one another and effecting a force-limited braking or attenuating effect for the at least one position of the drive lever.

6. The tank flap system according to claim 5, further including a leaf spring arranged on the base as a braking member and interacting with the contact contour of the base-side end region of the drive lever.

7. The tank flap system according to claim 3, further including a spring arrangement, the drive lever being is associated with the spring arrangement and the spring arrangement exerting on. the drive lever a permanent torque countering a gravitational torque exerted by gravity of the tank flap, wherein the torque is lower than a torque of the drive motor for moving the drive lever.

8. The tank flap system according to claim 7, wherein in that the spring arrangement is configured as a torsion spring acting coaxially to the rotary axis of the base-side end region of the drive lever and transmitting torque to the drive lever.

9. A tank flap system for a motor vehicle, comprising:
a base fixed to the motor vehicle in a state assembled ready for operation;
a tank flap;
a four-joint mechanism, the tank flap being mounted on the base by the four-joint mechanism so as to be movable between a closed position closing a tank recess and an open position exposing the tank recess;
a drive motor coupled to the four-joint mechanism to move the tank flap between the closed position and the open position; and
a drive lever rotatably joined to the base on a base side and to the tank flap on a flap side, the coupling lever being joined to a base-side end region of the drive lever at a distance to a base-side rotary axis of the drive lever in order to transmit rotary movements of the crank rocker to the drive lever.

10. The tank flap system according to claim 3, further including a spring arrangement, the drive lever being associated with the spring arrangement and the spring arrangement exerting on the drive lever a permanent torque countering a gravitational torque exerted by gravity of the tank flap in a direction of the closed position of the tank flap, and the torque is lower than a torque of the drive motor for moving the drive lever into the open position of the tank flap.
